(19) United States
(12) Patent Application Publication
(10) Pub. No.: US 2021/0334586 A1
(43) Pub. Date: Oct. 28, 2021

(54) EDGE LEARNING DISPLAY DEVICE AND METHOD

(71) Applicant: MediaTek Inc., Hsinchu (TW)

(72) Inventors: Chih-Wei Chen, Hsinchu (TW); Pei-Kuei Tsung, Hsinchu (TW); Chia-Da Lee, Hsinchu (TW); Yao-Sheng Wang, Hsinchu (TW); Hsiao-Chien Chiu, Hsinchu (TW); Cheng Lung Jen, Hsinchu (TW); Yu-Cheng Tseng, Hsinchu (TW); Kuo-Chiang Lo, Hsinchu (TW); Yu Chieh Lan, Hsinchu (TW)

(21) Appl. No.: 17/191,296

(22) Filed: Mar. 3, 2021

Related U.S. Application Data
(60) Provisional application No. 63/016,344, filed on Apr. 28, 2020.

(51) Int. Cl. G06K 9/62; G06T 5/00; G06F 3/0482; G06F 3/0484; G06F 16/58; G06F 16/51; G06N 20/00

(52) U.S. Cl. CPC G06K 9/6253; G06T 5/00; G06K 9/6256; G06F 3/0482; G06F 3/0484; G06K 9/6267; G06T 2207/10016; G06F 16/51; G06N 20/00; G06T 2207/20081; G06T 2207/20092; G06T 2200/24; G06F 16/5866

(57) ABSTRACT

An image processing circuit stores a training database and models in memory. The image processing circuit includes an attribute identification engine to identify an attribute from an input image according to a model stored in the memory. By enhancing the input image based on the identified attribute, a picture quality (PQ) engine in the image processing circuit generates an output image for display. The image processing circuit further includes a data collection module to generate a labeled image based on the input image labeled with the identified attribute, and to add the labeled image to the training database. A training engine in the image processing circuit then re-trains the model using the training database.

### CROSS-REFERENCE TO RELATED APPLICATIONS

This application claims the benefit of U.S. Provisional Application No. 63/016,344 filed on Apr. 28, 2020, the entirety of which is incorporated by reference herein.

### TECHNICAL FIELD

Embodiments of the invention relate to a device with image processing capability for enhancing picture quality.

### BACKGROUND

Modern devices with image display capabilities typically perform image enhancement operations when displaying images. For example, a television may enhance images or videos to be displayed on a screen, and a smartphone may enhance images or videos captured by or displayed on the smartphone. However, a conventional device typically performs image enhancement operations based on algorithms or formulations pre-configured by the device manufacturer. There is limited flexibility in adjusting the algorithms or formulations once the device is in use by a consumer. Thus, there is a need for improving the design of an image processing device to allow more flexibility in picture quality adjustment.

### SUMMARY

In one embodiment, an image processing circuit is provided in a device. The image processing circuit includes memory to store a training database and a plurality of models; an attribute identification engine to identify an attribute from an input image based on a model stored in the memory; a picture quality (PQ) engine to generate an output image for display by enhancing the input image based on the identified attribute; a data collection module to generate a labeled image based on the input image labeled with the identified attribute, and to add the labeled image to the training database; and a training engine to re-train the model using the training database.

In another embodiment, a method performed by a device for image enhancement is provided. An attribute is identified from an input image based on a model stored in the device. By enhancing the input image based on the identified attribute, an output image for display is generated. A labeled image is generated based on the input image labeled with the identified attribute. The labeled image is added to a training database stored in the device, and the model is re-trained using the training database.

In yet another embodiment, a method performed by a device for image enhancement is provided. A user-identified attribute for an input image is received via a user interface. A labeled image is generated based on the input image labeled with the user-identified attribute. The labeled image is added to a training database, and a model is re-trained using the training database. An output image is generated for display by enhancing the input image based on the model.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating an image processing circuit to perform picture quality enhancement according to one embodiment.

FIG. 2 is a block diagram illustrating automatic labeling according to one embodiment.

FIG. 3 is a block diagram illustrating manual labeling according to one embodiment.

FIG. 4A illustrates an example of an image with an incorrectly identified scene type attribute according to one embodiment.

FIG. 4B illustrates an example of a sample image for manual labeling according to one embodiment.

FIG. 5 is a flow diagram illustrating a method for a device to perform image enhancement operations according to one embodiment.

FIG. 6 illustrates an example of a device according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

A device including an image processing circuit is described herein. A user may view images (e.g., a video) on a display panel coupled to the image processing circuit. The image processing circuit generates a training database containing the images that are labeled automatically and/or manually. The image processing circuit further uses the training database to re-train one or more models, based on which one or more attributes of the images are identified. A picture quality (PQ) engine enhances the quality of output images by changing certain image values associated with the identified attributes. If a user is not satisfied with the quality of output images shown on the display panel, the user may provide feedback to the device to help re-train the models that were used for generating the identified attributes. Thus, users can tailor the training database and the models according to their viewing experiences and preferences, and, as a result, the device provides flexibility in image quality adjustment.

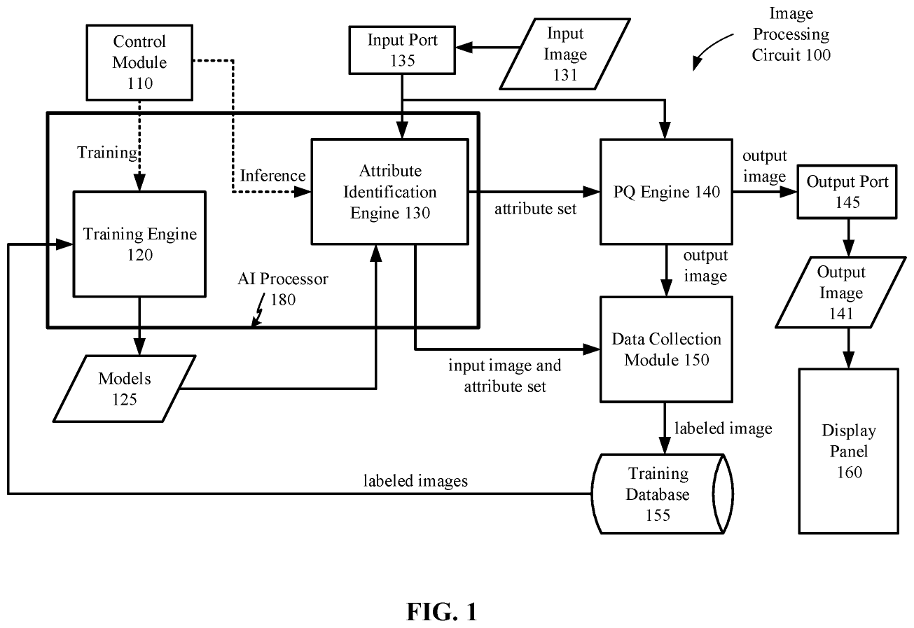

FIG. 1 is a block diagram illustrating an image processing circuit 100 performing picture quality enhancement according to one embodiment. The image processing circuit 100 may be part of a device, also referred to as an edge device, such as a television, a smartphone, a computing device, a network-connected device, a gaming device, an entertainment device, an Internet-of-things (IoT) device, or any device capable of processing and displaying images and/or videos. The images to be processed may be captured by the same device, or by a different source and then downloaded, streamed, transferred, or otherwise accessible to the device. In some embodiments, the image processing circuit 100 may include an artificial intelligence (AI) processor 180 coupled to a picture quality (PQ) engine 140. The AI processor 180 can be trained to infer representative characteristics in input images, and the PQ engine 140 can enhance the picture quality of the input images based on the representative characteristics.

The image processing circuit 100 includes an input port 135 for receiving an input image 131 and an output port 145 for outputting an output image 141, which, in this example, is the processed image of the input image 131. The output image 141 is sent to a display panel 160 for display. For ease of description, an input image and its corresponding output image are provided as an example. It is understood that the following description is applicable when the image processing circuit 100 receives an image sequence (e.g., a video) as input and generates a corresponding image sequence as output.

The image processing circuit 100 further includes a control module 110 which sends control signals (shown in dotted lines) to control and manage on-device training and inference operations. The control module 110 triggers training operations performed by a training engine 120 to train or re-train models 125 with labeled images from a training database 155. The control module 110 also triggers inference operations performed by an attribute identification engine 130 to identify attributes (i.e., representative characteristics) in the input image 131. In one embodiment, the attribute identification engine 130 may identify the attributes by inference and/or measurement based on one or more models 125. The attribute identified by the attribute identification engine 130 may be a type (e.g., a scene type or an object type), statistic information, or a feature in the image content. For example, the attributes may include a scene type, types of objects in a scene, contrast information (e.g., histogram or statistics), luminance information (e.g., histogram or statistics), edge directions and strength, noise and degree of blur, segmentation information, motion information, etc. In some embodiments, the attribute may be identified using a machine-learning or deep-learning algorithm.

In some embodiments, the image processing circuit 100 may be implemented in a system-on-a-chip (SoC). In some embodiments, the image processing circuit 100 may be implemented in more than one chip in the same electronic device.

In one embodiment, the attribute identification engine 130 may identify multiple attributes from an image (e.g., a scene type as well as contrast information), which are collectively referred to as an attribute set of the image. The attribute identification engine 130 may further generate a confidence level of an identified attribute; e.g., 75% confidence for the nature scene type. A high confidence level (e.g., when the confidence level exceeds a threshold) indicates that the identified attribute has a correspondingly high probability to be correctly identified. The attribute identification engine 130 sends the attribute set to the PQ engine 140 and a data collection module 150.

In one embodiment, the PQ engine 140 performs image enhancement operations on the input image 131 using image processing algorithms based on the attribute set of the input image 131. Different algorithms may be used for different attributes; e.g., an algorithm for noise reduction, another algorithm for a nature scene, and yet another algorithm for a scene type of food. In some embodiments, the PQ engine 140 may perform one or more of the following operations: de-noising, scaling, contrast adjustment, color adjustment, and sharpness adjustment. For example, the PQ engine 140 may increase the warmth of the image color in a food scene, increase the sharpness in a blurry image, and de-noise in a noisy image. The output of the PQ engine 140 is the output image 141, which is sent to the data collection module 150 and the output port 145.

The data collection module 150 receives the output image 141 from the PQ engine 140, and also receives the input image 131 and the attribute set of the input image 131 from the attribute identification engine 130. In one embodiment, one or more identified attributes in the attribute set may be attached with respective confidence levels.

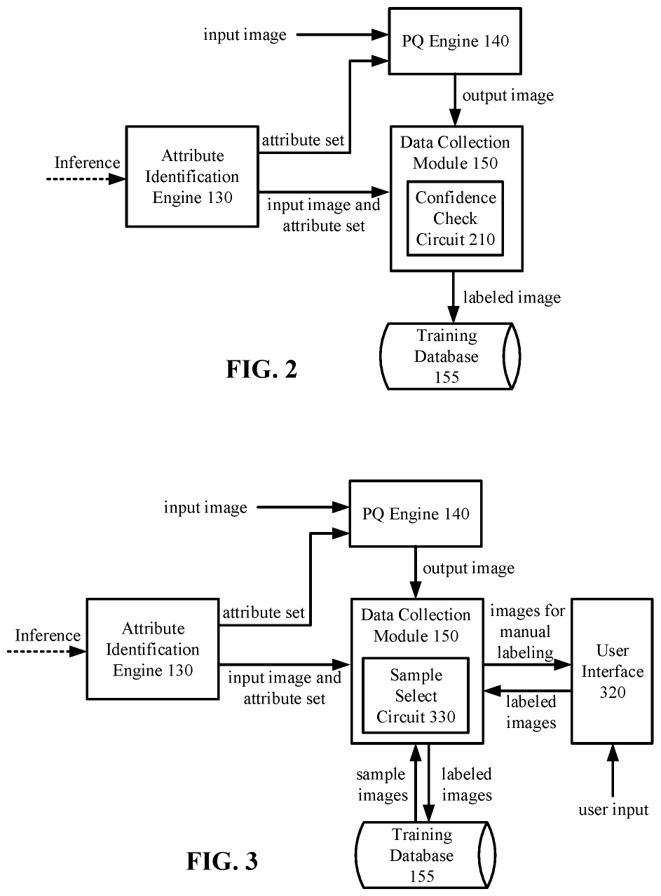

The data collection module 150 is a part of the image processing circuit 100 which provides labeled images to the training database 155. In a manual labeling approach, the input image 131 is labeled by a user. In an automatic labeling approach, the input image 131 is automatically labeled with identified attributes of high confidence levels. The automatic labeling and the manual labeling will be described with reference to FIG. 2 and FIG. 3, respectively.

The control module 110 may trigger the training engine 120 to perform training operations to train and/or re-train models 125 with the labeled images from the training database 155. The training operations may be performed periodically or based on events. For example, the training operations may start when the image processing circuit 100 enters a sleep state or an idle state. For an edge device with limited processing resources (e.g., a smart TV, a smartphone, an IoT device, etc.), the models 125 may be initially trained on a server such as a cloud server, and re-trained on the edge device by the training engine 120 based on images or videos viewed on the edge device. The training operations change the weights or parameters in the models 125, such as filter weights in an image filter, kernel weights in a neural network kernel, thresholds, etc. In some embodiments, the training operations may be performed by machine learning, deep learning, or other types of learning operations.

FIG. 2 is a block diagram illustrating automatic labeling according to one embodiment. In FIG. 2, only the inference part of the image processing circuit 100 is illustrated. In this embodiment, the data collection module 150 includes a confidence check circuit 210, which compares the confidence level of an identified attribute of an input image with a threshold. Different attributes may be compared with different thresholds. The data collection module 150 labels the input image with the identified attribute that exceeds its confidence threshold, and updates the training database 155 with the labeled image for on-device training operations. For example, an input image may be identified to have the following attributes: an urban street scene type, object types of cars, people, and buildings, and 80% contrast. If the urban street scene type is identified to have a high confidence level (i.e., exceeding its confidence threshold), the data collection module 150 is to label the input image as having the urban street scene type. The data collection module 150 may further label the input image with other attributes having confidence levels exceeding their respective confidence thresholds. The labeled image is then stored in the training database 155

FIG. 3 is a block diagram illustrating manual labeling according to one embodiment. In FIG. 3, only the inference part of the image processing circuit 100 is illustrated. In this embodiment, the data collection module 150 is coupled to a user interface 320 to receive a user's feedback on a displayed image. The user interface 320 may provide a graphical user interface (GUI) on a display panel, a voice-controlled user interface to receive a user's voice commands, or other means for receiving user's input regarding a displayed image. Via the user interface 320, a user may indicate that one or more of the images have poor picture quality and request to start a manual labeling process. Referring also to FIG. 1, the output image 141 is an example of a displayed image. In the description hereinafter, the terms “displayed image” and “output image” are used interchangeably.

In one embodiment, the manual labeling may be performed on demand by a user. A user may mark a displayed image as having poor picture quality; e.g., by selecting a button, and the marking action triggers the start of a manual labeling process. Alternatively, a user may request to start a manual labeling process at any time regarding any image attribute. The image processing circuit 100, in response, requests the user to label the displayed image or the corresponding input image with a correct value or type of an attribute, where the “correctness” may be determined from the user's perspective. In one embodiment, the user interface 320 may present the user with a number of selectable values or types to replace the device-identified attribute. Using the scene type as an example, the user interface 320 may present the user with options such as “people”, “food”, “nature”, “landmark” to select as the scene type attribute for an image. The user may select one of the presented types (e.g., people) to indicate the correct scene type attribute for the image. In one embodiment, the user may add a new label such as “animals” to indicate the correct scene type attribute for the image.

To improve the training accuracy, the data collection module 150 may retrieve, from the training database 155, multiple sample images that are similar to the user-labeled image with respect to an attribute of interest. In one embodiment, the data collection module 150 includes a sample select circuit 330, which selects sample images from the training database 155 and provides the selected sample images to the user. Each of the selected sample images has a confidence level exceeding a predetermined threshold with respect to the attribute of interest. For example, the sample image may be displayed on the display panel along with a list of selectable values or types of an attribute of interest. A user may label a sample image by selecting a value or type from the list. In some embodiments, a user may add a new value or a new type to the attribute of interest. Using the above example in which scene type is the attribute of interest, each sample image may be presented with a list of people”, “food”, “nature”, “landmark” for the user to select. The user may select from the list. Alternatively, the user may add “animals” to the list as a new option for the scene type. The manual labeling process ends when the user labels all of the sample images provided by the sample select circuit 330.

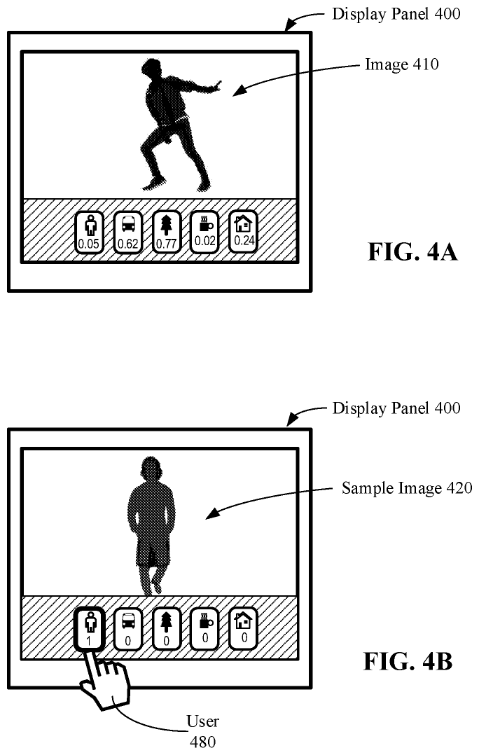

FIG. 4A illustrates an example of an output image with an incorrectly identified scene type attribute according to one embodiment. The display panel 400 may be coupled to the output port 145 of the image processing circuit 100 (FIG. 1). A user may mark an image 410 of a person as having poor picture quality; e.g., by selecting a button or commanding by voice or other means when the image 410 is displayed. In response, the image processing circuit 100 presents the image 410 with a list of scene types for the scene type attribute. The image processing circuit 100 may also present values, types, or information of other attributes of the image 410 to the user in prior or subsequent lists. For the scene type attribute, the display panel 400 shows the image 410 with the automatically generated confidence level for each scene type: e.g., people (0.05), vehicle (0.62), tree (0.77), drink (0.02), and house (0.23), where each number in the parenthesis indicates the confidence level of the corresponding scene type in the image. According to the confidence levels, the attribute identification engine 130 identifies a tree scene type. The tree scene type in this example is the identified attribute. Based on this identified attribute, the PQ engine 140 may apply an algorithm for enhancing a tree scene to generate an output image.

However, a user can determine, from the image 410, that the correct scene type attribute should be “people.” For this image 410, the people scene type is a user-identified attribute that is different from the device-identified attribute of a tree scene type. In this example, the user may select the “people” tab to change the device-identified attribute for the image 410. The user-identified scene type of people becomes a label of the image 410.

After the user labels the image 410 with a corrected attribute, the image processing circuit 100 may present the user with a number of sample images that were previously identified as the people scene type. The user may label these sample images with respect to the scene type to indicate whether or not they were correctly identified as containing the people scene type. FIG. 4B illustrates one of the sample images 420 as an example. The data collection module 140 stores the user-labeled images, including the user-labeled image 410 and the user-labeled sample images 420, into the training database 155.

The training engine 120 uses the labeled images from the training database 155 to re-train the models 125. The models 125 may have been trained to detect a feature (e.g., edge directions and strength, segmentation information, motion, etc.) in an image or an image sequence, classify the image content, measure a condition of an image (e.g., contrast, sharpness, brightness, luminance, noise, etc.), etc. The models 125 may be described by mathematical formulations or representations. The models 125 may initially be installed in the image processing circuit 100 and can be re-trained, or refined, with labeled images to learn from the user's image viewing experience on the device.

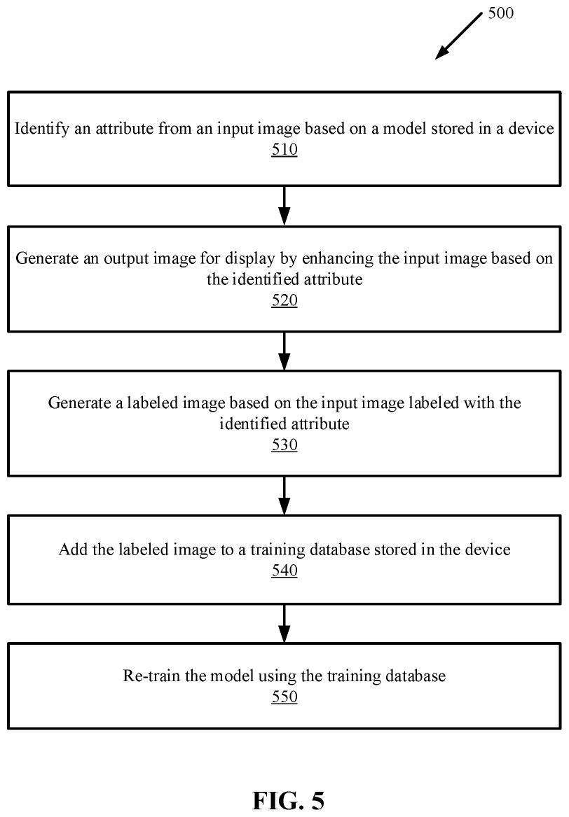

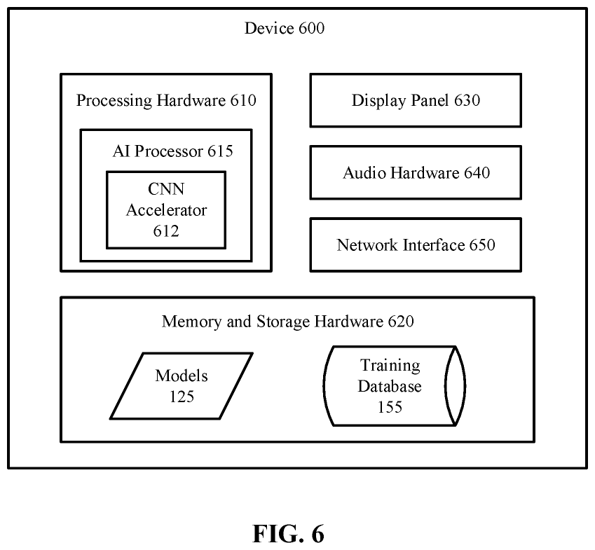

FIG. 5 is a flow diagram illustrating a method 500 for image enhancement according to one embodiment. In some embodiments, the image enhancement operations described herein include generating training data and re-training a model. The method 500 may be performed, for example, by the image processing circuit 100 of FIG. 1 and/or the device 600 of FIG. 6. It is understood that FIG. 1 and FIG. 6 are for illustrative purposes only; other image processing devices may perform the method 500.

The method 500 begins at step 510 with the device identifying an attribute from an input image based on a model stored in the device. At step 520, the device generates an output image for display by enhancing the input image based on the identified attribute. At step 530, the device generates a labeled image based on the input image labeled with the identified attribute. At step 540, the device adds the labeled image to a training database stored in the device. At step 550, the device re-trains the model using the training database. In one embodiment, the model may be re-trained on the device.

FIG. 6 illustrates an example of a device 600 according to one embodiment. The device 600 may include the image processing circuit 100 of FIG. 1, which performs the aforementioned image enhancement operations. The device 600 includes processing hardware 610. In one embodiment, the processing hardware 610 may include one or more processors, such as central processing units (CPUs), graphics processing units (GPUs), digital processing units (DSPs), multimedia processors, and other general-purpose and/or special-purpose processing circuitry. In one embodiment, the processing hardware 610 may include hardware circuitry including but not limited to: the attribute identification engine 130, the PQ engine 140, the data collection module 150, and the training engine 120 in FIG. 1. Additionally or alternatively, the processing hardware 610 may include an artificial intelligence (AI) processor 615, which may be an example of the AI processor 180 in FIG. 1. Referring back to FIG. 1, in one embodiment, the training engine 120 and/or the attribute identification engine 130 may be part of the AI processor 615. In one embodiment, the AI processor 615 may be part of a GPU. In one embodiment, the AI processor 615 may include a hardware accelerator, such as a convolution neural network (CNN) accelerator 612.

The CNN accelerator 612 includes hardware components specialized for accelerating neural network operations by convolutional operations, fully-connected operations, activation, pooling, normalization, element-wise mathematical computations, etc. In some embodiments, the CNN accelerator 612 includes multiple compute units and memory (e.g., Static Random Access Memory (SRAM)), where each compute unit further includes multipliers and adder circuits, among others, for performing mathematical operations such as multiply-and-accumulate (MAC) operations to accelerate the convolution, activation, pooling, normalization, and other neural network operations. The CNN accelerator 612 may perform fixed and floating-point neural network operations. In connection with the picture quality enhancement described herein, the CNN accelerator 612 may perform training and inference operations described in connection with FIG. 1.

The device 600 further includes a memory and storage hardware 620 coupled to the processing hardware 610. The memory and storage hardware 620 may include memory devices such as dynamic random access memory (DRAM), SRAM, flash memory, and other non-transitory machine-readable storage medium; e.g., volatile or non-volatile memory devices. The memory and storage hardware 620 may further include storage devices, for example, any type of solid-state or magnetic storage device. In one embodiment, the memory and storage hardware 620 may store the models 125 and the training database 155 of FIG. 1. In some embodiments, the memory and storage hardware 620 may store instructions which, when executed by the processing hardware 610, cause the processing hardware 610 to perform the aforementioned image enhancement operations, such as the method 500 of FIG. 5.

The device 600 may also include a display panel 630 to display information such as images, videos, messages, Web pages, games, texts, and other types of text, image, and video data. The images may be labeled by a user via a user interface, such as a keyboard, a touchpad, a touch screen, a mouse, a touch screen, etc. The device 600 may also include audio hardware 640, such as a microphone and a speaker, for receiving and generating sounds. The audio hardware 640 may also provide a user interface for sending and receiving voice commands.

In some embodiments, the device 600 may also include a network interface 650 to connect to a wired and/or wireless network for transmitting and/or receiving voice, digital data and/or media signals. It is understood the embodiment of FIG. 6 is simplified for illustration purposes. Additional hardware components may be included.

The operations of the flow diagram of FIG. 5 have been described with reference to the exemplary embodiments of FIG. 1 and FIG. 6. However, it should be understood that the operations of the flow diagram of FIG. 5 can be performed by embodiments of the invention other than the embodiments of FIG. 1 and FIG. 6, and the embodiments of FIG. 1 and FIG. 6 can perform operations different than those discussed with reference to the flow diagram. While the flow diagram of FIG. 5 shows a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. An image processing circuit, comprising:
an attribute identification engine to identify an attribute from an input image based on a model stored in a memory;
a picture quality (PQ) engine to generate an output image for display by enhancing the input image based on the identified attribute;
a data collection module to generate a labeled image based on the input image labeled with the identified attribute, and to add the labeled image to a training database stored in the memory; and
a training engine to re-train the model using the training database.

2. The image processing circuit of claim 1, further comprising an artificial intelligence (AI) processor which includes, at least in part, the attribute identification engine operative to execute a machine-learning or deep-learning algorithm to identify the attribute.

3. The image processing circuit of claim 1, further comprising a control module to control re-training of the model on the device based on an event or a periodic schedule.

4. The image processing circuit of claim 1, wherein the data collection module is further operative to:
receive, via a user interface, a user-identified attribute which changes the identified attribute for the input image; and
generate the labeled image based on the input image labeled with the user-identified attribute.

5. The image processing circuit of claim 4, wherein the user interface provides a list of options with respect to the identified attribute for selection by a user in response to an indication from the user.

6. The image processing circuit of claim 4, wherein the data collection module is further operative to:
retrieve a plurality of sample images from the training database, each sample image having a confidence level exceeding a predetermined threshold with respect to the user-identified attribute; and
providing each sample image for the user to label to thereby generate labeled images for the training database.

7. The image processing circuit of claim 1, wherein the data collection module is further operative to:
automatically label the input image with the identified attribute when a confidence level with respect to the identified attribute exceeds a predetermined threshold; and
update the training database with automatically labeled images.

8. The image processing circuit of claim 1, wherein the attributes of the input image include one or more of: a scene type, an object type in a scene, contrast information, luminance information, edge directions or strength, noise information, segmentation information, and motion information.

9. The image processing circuit of claim 1, wherein the attribute identification module is further operative to identify a plurality of attributes from an image sequence according to the plurality of models, wherein each model is used for identifying one of the attributes.

10. The image processing circuit of claim 1, wherein the PQ engine is operative to perform the image processing including one or more of: de-noising, scaling, contrast adjustment, color adjustment, and sharpness adjustment.

11. A method performed by a device for image enhancement, comprising:
identifying an attribute from an input image based on a model stored in the device;
generating an output image for display by enhancing the input image based on the identified attribute;
generating a labeled image based on the input image labeled with the identified attribute;
adding the labeled image to a training database stored in the device; and
re-training the model using the training database.

12. The method of claim 11, wherein identifying the attribute further comprises:
identifying the attribute using a machine-learning or deep-learning algorithm.

13. The method of claim 11, further comprising:
re-training the model on the device based on an event or a periodic schedule.

14. The method of claim 11, wherein generating the labeled image further comprises:
receiving a user-identified attribute which changes the identified attribute for the input image; and
generating the labeled image based on the input image labeled with the user-identified attribute.

15. The method of claim 14, further comprising:
displaying a list of options with respect to the identified attribute for selection by a user in response to an indication from the user.

16. The method of claim 14, further comprising:
retrieving a plurality of sample images from the training database, each sample image having a confidence level exceeding a predetermined threshold with respect to the user-identified attribute; and
displaying each sample image for the user to label to thereby generate labeled images for the training database.

17. The method of claim 11, wherein generating the labeled image further comprises:
automatically labeling the input image with the identified attribute when a confidence level with respect to the identified attribute exceeds a predetermined threshold; and
updating the training database with automatically labeled images.

18. The method of claim 11, wherein attributes of the input image include one or more of: a scene type, an object type in a scene, contrast information, luminance information, edge directions or strength, noise information, segmentation information, and motion information.

19. The method of claim 11, further comprising:
identifying a plurality of attributes from an image sequence according to a plurality of models, wherein each model is used for identifying one of the attributes.

20. The method of claim 11, wherein processing the input image further comprises performing one or more of: de-noising, scaling, contrast adjustment, color adjustment, and sharpness adjustment.

21. A method performed by a device for image enhancement, comprising:
receiving, via a user interface, a user-identified attribute for an input image;
generating a labeled image based on the input image labeled with the user-identified attribute;
adding the labeled image to a training database;
re-training a model using the training database; and
generating an output image for display by enhancing the input image based on the model.

22. The method of claim 21, further comprising:
displaying a list of options with respect to attributes for selection by a user in response to an indication from the user.

23. The method of claim 21, further comprising:
retrieving a plurality of sample images from the training database, each sample image having a confidence level exceeding a predetermined threshold with respect to the user-identified attribute; and
displaying each sample image for the user to label to thereby generate labeled images for the training database.

24. The method of claim 21, further comprises:
automatically labeling an input image with identified attribute when a confidence level with respect to the identified attribute exceeds a predetermined threshold; and
updating the training database with automatically labeled images.

25. The method of claim 21, wherein attributes of the input image include one or more of: a scene type, an object type in a scene, contrast information, luminance information, edge directions or strength, noise information, segmentation information, and motion information.
